(19) United States
(12) Patent Application Publication
(10) Pub. No.: US 2020/0305491 A1
(43) Pub. Date: Oct. 1, 2020

(54) MACHINE AND METHOD FOR PITTING FRUITS

(71) Applicant: Axel Dinter, Neuenkirchen (DE)

(72) Inventor: Axel Dinter, Neuenkirchen (DE)

(21) Appl. No.: 16/623,039

(22) PCT Filed: Jun. 22, 2018
(86) PCT No.: PCT/DE2018/100583

§ 371 Date: Dec. 16, 2019

(30) Foreign Application Priority Data
Jun. 27, 2017 (DE) 20 2017 103 821.1

(51) Int. Cl. A23N 4/06; A23N 3/04

(52) U.S. Cl. CPC A23N 4/06; A23N 4/04; A23N 3/04

(57) ABSTRACT

A machine for pitting fruits, having a plurality of plungers (4) and a plurality of receiving elements (13) for the fruits (F) that are to be pitted. Each receiving element (13) has a bowl (3) which accommodates an individual fruit (F). Each bowl has a passage opening (31) for the pit which has been extracted from the fruit (F). The machine is characterized in that first sensors are provided upstream of a working section (14) for detecting the bowls (3) that contain two fruits. The invention further relates to a method for pitting fruits.

The invention relates to a machine for pitting fruits, with a plurality of plungers and a plurality of receiving elements for the fruits to be pitted, each receiving element having a single fruit receiving cup with a passage opening for the pit to be pushed out of the fruit, the receiving elements on a circulating receiving elements track and the plungers on a circulating plunger track along a working path parallel and synchronously guided to each other and, along the working segment, means are provided for performing a reciprocating movement of the plunger relative to the cups. Furthermore, the invention relates to a method for pitting fruits with this machine.

One machine and method of this type is known from U.S. Pat. No. 3,061,070 A. There, an orchard machine for pitting cherries or other spherical pit fruits is described, wherein receiving elements are guided on a circulating receiving element track and plungers are guided on a circulating plunger track and means are provided along a working segment for performing a reciprocating movement of the plunger relative to the cups. Here, the fruit to be processed is deposited individually in a bowl-shaped cup and aligned by a rotatably driven plunger.

Furthermore, from DE 814 963 a cherry pitting machine is known. By means of the cup, which is formed elastically, it is achieved with this cherry pitting machine that pits that are not centrally arranged or pits of various sizes are engaged up by a punch and are moved and ejected radially through the fruit without destroying the stone or pit. Thus, the unwanted smashing of pits could be largely avoided with this device.

Nevertheless, there is the problem that not properly pitted fruits are represented as allegedly pitted fruits. It has been found that it is precisely the discontinuous run during the pitting that results in a fruit not being adequately centered in the cup-like receptacle despite appropriate shape of the cup, so that the plunger for expelling the pit is not, or not optimally, centered and thus the pit is pushed aside or even smashed. This problem has already been recognized in DE 41 12 548 C1, and a continuous run of receptacles for the fruits described there as pitting tiles. A disadvantage of this device is the still discontinuous running of the hub device, which is both less energy efficient and in terms of reciprocating masses leads to unwanted vibrations and higher friction wear.

On the other hand, DE 10 2005 018 639 B3 describes a quality control in fruit pitting in which a device is provided for monitoring a predetermined event along a pit removal path, wherein the device for monitoring the removal path uses X-rays.

DE 11 20 797 A describes a pitting machine for pit fruit, especially for cherries and sour cherries, in which a brush roller is used to remove excess amounts of the fruit, so those pieces that are not nested are removed from the strand, but this may lead in part to incorrect placements, damage and/or hygienic compromise.

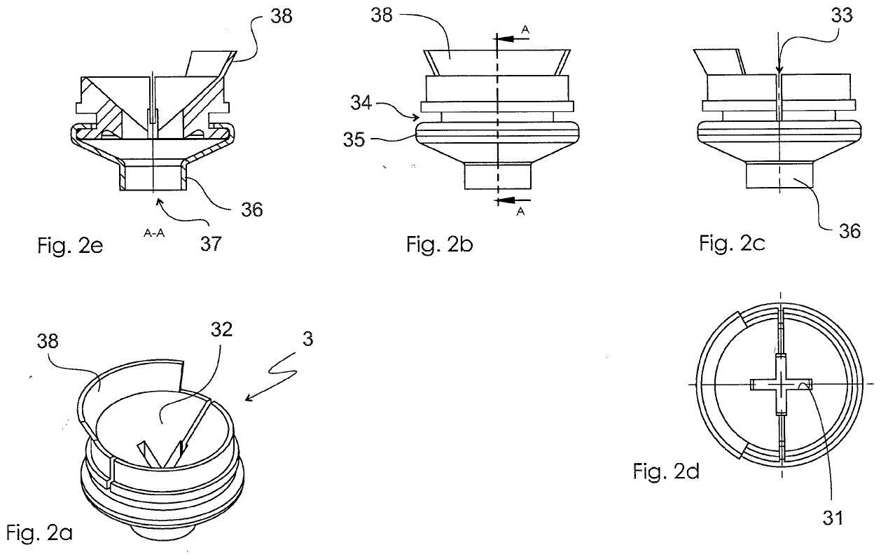

U.S. Pat. No. 1,329,023 A concerns a plum pitting machine which holds the plums to be pitted between two endless belts, each with associated half-shells, and has a plunger mechanism parallel to the axes of rotation of the endless belts (FIG. 2) which pushes out the core of the respectively held plum.

Overall, it is therefore an object of the invention to provide a machine and a method for pitting fruits, in which an output of incorrectly pitted fruits is prevented.

This object is achieved with a machine for pitting of fruit according to claim 1 and a method for pitting of fruit according to claim 12.

By providing first sensors upstream of the working segment, cups having double occupancy of fruit can be detected. It has in fact been found that, despite individualized feeding of the fruit, every now and then cups of the pitting machine are occupied with two fruits, after which a proper pitting in the working segment is not possible. By detecting with cups double-occupied with fruits precautions can be taken that fruits are sorted out at this position before the working segment, preferably blown out. Thus, it can be safely avoided that cups double-occupied with fruit lead to a flaw in the pitting process.

In a further embodiment, it is preferred that second sensors are provided below the working segment, which detect the expulsion of the pit. If the expulsion of the pit of each fruit processed on the working segment is positively recognized, fruits at positions where an expulsion of a pit could not be detected may be sorted out as possibly erroneously pitted fruit, preferably blown out.

With the design of the device with sensors upstream and below the working segment very significant sources of error for an improper pitting process can be reliably detected and corrected in the context of sorting operations. Thus, the quality of the pitting process is detected with very high accuracy, so that the final product, namely the pitted fruits, are free of pits and pit remains.

The cup receiving a single fruit may be formed, as is conventional in the art, from an elastic plastic. Alternatively, it is also possible that the cup is made of a solid material, preferably food-safe material, such as stainless steel, precisely coordinated with the guidance of an associated plunger. Thereby even very high hygienic requirements can be fulfilled.

Therein, optical, acoustic, magnetic detection and/or detection by means of strain gauges can be provided as the first or second sensors.

By providing an elastic sleeve below the throughput opening on the cup, through which the pit to be removed from the fruit by means of the plunger can be squeezed, the pit is cleaned from any other flesh of the fruit while being pushed through the sleeve. Furthermore, using the expansion of the sleeve, the expulsion of the pit is easier to detect.

If magnetization marks or strain gauges are arranged on the elastic sleeve, the passage through of the pit can be reliably be detected using these.

The fact that a checking device for sorting out erroneously pitted fruits before issuing the pitted fruits for further processing is arranged downstream of the working segment, a very high accuracy of the output pitted fruits can be achieved.

If the checking device is a second blower, which blows out a defective pitted fruit detected by the second sensors into a sorting container arranged laterally to the direction of transport of the receiving element track and downstream of the working segment, defective pitted fruits are sorted out before output of pitted fruits for further processing and in blown out the container.

Since a checking device is provided upstream of the working segment and downstream of the first sensor, fruit not correctly placed on the receiving elements can be sorted out. Also for this purpose, a blow-out device is preferably provided, which with the first sensor recognizes fruit incorrectly placed on a receiving element. In this case, in particular, double-occupied receiving elements (cups) are detected, so that, by applying a targeted air blast on this receiving element, incorrectly resting fruit in double occupancy are blown into a receptacle before the working segment, so this receiving element travels empty in the working segment. Accordingly, no error in the pit removal can arise here. The blown fruits can be fed again, since this is usually only a case of a random incorrect occupancy of a receiving element.

Preferably, the plunger has cross-shaped, five-star or six-star cross-section, wherein the pass-through opening in the cup is designed to match. Thus, by the elastic counter-bearing to the punch described in DE 814 963, here a plunger, is optimized insofar that as the pit, centered by the plunger, while being moved through the pass-through opening, is at the same time stripped largely of the pulp by elastic expansion of the cross-shaped, five-star or six-star pass-through opening during the movement process.

Next, the plunger track is arranged above the receiving element track so that the fruits are held by gravity in the receiving elements and the pits to be removed from the fruits can be pushed out from top to bottom.

Since a curved element and a plunger holder for each plunger are provided on the plunger track, and the reciprocating movement of the plunger slidably mounted in the plunger holder is controlled by the curved element, the reciprocating movement is directed by guidance of the curved element in the manner of a cam guide in the working segment. According to the design of the curved element, a harmonious, low-wear movement can be generated synchronously to the movement of the entire system.

If a sleeve is provided under each plunger holder, sitting on the fruit during the reciprocating movement of the plunger and holding the fruit in the cup after pitting, it is achieved that the respective fruit is better centered and securely held. In addition, the sleeve quasi formed as a negative mold of the fruit to be pitted serves as a scraper so that the fruit pierced by the plunger does not stick to the plunger and becomes lifted from the cup. Thus, each fruit remains exactly in the receiving element or cup in which it was pitted. Advantageously, the sleeve is lifted only after the return movement of the plunger when the plunger has already emerged upwards from the fruit. This also makes subsequent processing (checking) for quality assurance easier or in some cases enabled. Due to the exact assignment of the fruit to the respective receiving element (cup), the processing can thus follow a precise protocol and be utilized for quality assurance.

Preferably, on the receiving element track upstream of the working segment, a fruit delivery arrangement is provided for the individualized supply of fruit, one fruit to be pitted per cup, the singling out of fruit ensuring that only one fruit is deposited per cup.

According to the method the working segment for pitting of fruits is thus monitored using measuring technology as to whether one fruit or several fruits rest on a cup. If several fruits rest on one cup, they will be ejected. Thus, this cup then proceeds empty in the working route, but at least a faulty pitting process is avoided.

If, after the ejection of the fruits from a cup having several fruits, this cup is checked downstream of the working segment as to whether the fruit ejection in fact took place, and in the event of a faulty ejection a second ejection is made by means of compressed air shock, then any selection errors are corrected. It is important that this second attempt is also made before the work segment, so that it is ensured that not properly resting fruit are removed from the cup before they are subjected to the pitting process.

The fact that the working segment is monitored with measuring instruments for discharge of a pit below the passage opening, wherein the fruits of each cup from which a pit discharge has not been detected, is discharged downstream of the working line, it is also positively checked whether a pit is discharged under the passage opening during the pitting process. If a pit discharge can not be confirmed, the fruit, which is obviously not properly pitted, is discharged from the relevant cup, in particular blown out laterally by means of a blow-out device into a collecting container for fruit to be disposed of with any pits or pit remnants. The other properly pitted fruits are conveyed in their cups to the output for the pitted pulp.

If, after discharging erroneously pitted fruits downstream of the working segment, the respective cup is checked as to whether the fruit discharge took place, and in the event of a faulty discharge a second discharge by means of compressed air shock is made, then again, the discharge is checked on those cups on which faulty pitted fruits had rested. Thus, the fruit discharge can be checked here again in a kind of follow-up and sorted out by a second attempt by means of compressed air blast.

Overall, a very high quality of the pitting process is ensured.

In the following the invention will be described in detail below on the basis of an illustrative embodiment with reference to the accompanying drawings.

There is shown in:

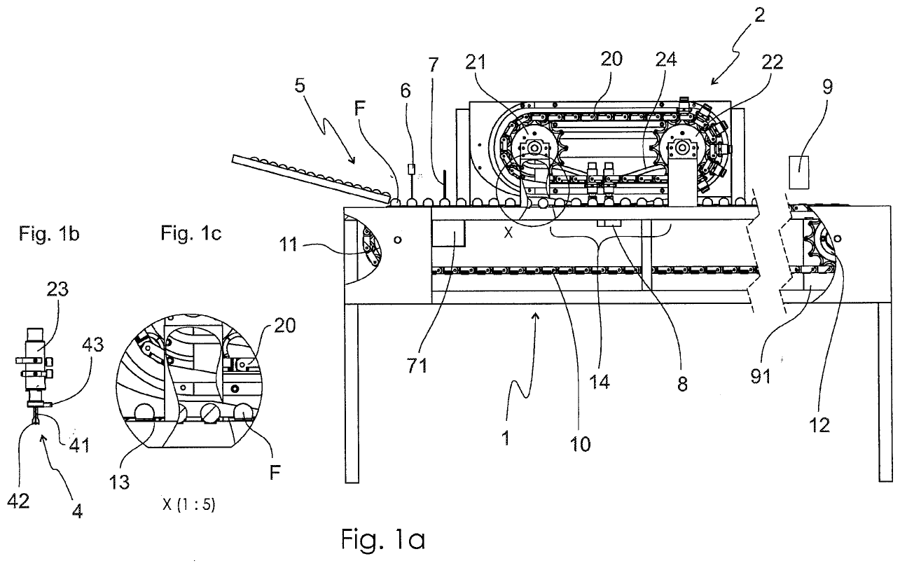

FIG. 1 a machine for pitting fruit
a) in a schematic side view
b) in detail with a plunger assembly inserted therein and
c) in a detailed view corresponding to X of FIG. 1a) and

FIG. 2 a cup of a receiving element in
a) spatial view,
b) side view,
c) side view rotated 90° to side view according to FIG. 2b,
d) plan view and
e) internal FIG. 2b shown cross-sectional view.

In FIG. 1, an illustrative embodiment of a machine for pitting of fruit is shown in schematic side view. The machine has a circulating receiving element track 1, which has a conveyor 10 guided in a closed loop around two deflecting wheels/rollers 11, 12, on which a plurality of receiving elements 13 are arranged so that fruits to be pitted can be deposited on the receiving elements 13 from the outside.

Above the receiving element track 1, a circulating plunger track 2 is arranged, which likewise has a conveying means 20 guided in a closed loop around deflection rollers/wheels 21, 22. At the second conveyor 20 plunger holders 23 are arranged laterally in a suitable manner the same way as the receiving elements 13 on the first conveyor 10.

The circulating receiving element track 1 and the circulating plunger track 2 are driven synchronously to each other, wherein in the case of the circulating receiving element track 1, an upper part of the first conveyor 10 running to the right in FIG. 1 directly faces the lower, also running to the right, part of the second conveyor 20 of the circulating plunger track 2. This area is the working segment 14, in the progression of which the fruit is pitted. For this purpose, a curved element 24 runs along the lower part of the circulating plunger track 2 that interacts with the plungers 4 held in the plunger holders 23 such that the plungers 4 are pushed out in the plunger holder 23 and pushed back again. Each plunger 4 is comprised, in particular for the pitting of cherries, of a long shaft 41 with a cross-shaped cross-section, a plunger tip 42 with concave or V-shape for centering of the pit to be pushed out of the fruit, and a contact element 43 that comes to rest on the curved track member 24. For other fruits and their pits to be removed, other plunger shapes, for example, with a 5- or 6- pointed star cross section and/or with a straight tip, may be particularly suitable.

On each receiving element 13, a cup 3 made of an elastic plastic is arranged. The cup 3 has the shape shown in detail in FIG. 2. The cup 3 consisting of elastic plastic has a passage opening 31 which is formed cross-shaped and matching the cross section of the shaft 41 of the plunger 4. In addition, the cup 3 has on its upper side a concave or inverted conical receptacle 32 on which the fruit to be pitted can be placed. In addition to the passage opening 31, the cup 3 has a vertical slot 33 which is oriented along two opposite legs of the cross-shaped passage opening 31 and divides the receptacle 32 in two.

In the lower region of the cup 3, a groove 34 and a bead 35 are formed, wherein a sleeve 36 is formed below in the installation direction, which tapers significantly from the bead 35 and ends with a circular opening (base opening 37) with a base area quasi in the form of a hose section. The base opening 37 has an inner diameter slightly smaller than the pits from the fruits to be pitted.

In a particularly preferred embodiment, the cup 3 has an elevation 38 over a portion of an edge on the upper circumference of the receptacle 32, leading in operation in the direction of movement, so that the edge elevation 38 serves to decelerate a fruit fed by delivery arrangement 5 in the direction of movement when landing in the cup and to keep it in. In this case, the fruit delivery arrangement 5 preferably also has a device for separating the fruits, in order to individually dispense each fruit singly onto the receiving elements 13. This prevents that two or even three fruits rest on a receiving element. In this case, the pitting process would fail at least for the additional fruits riding thereon. The fruit feed arrangement 5 is shown schematically in FIG. 1 at the upstream end in front of the working segment 14.

Between the fruit delivery arrangement 5 and the working segment 14 first sensors 6 are provided, which can detect cups 3 double-occupied with fruits. The first sensors 6 can be optical, acoustic, magnetic and/or electrical sensors which, together with an associated electronic evaluation unit, analyze the measured values and locate faulty occupied receiving elements 13. These receiving elements 13 incorrectly occupied with fruits are then blown by a blower 7 into a sorting container 71.

Similarly, a monitoring of the pitting process takes place along the working segment 14 by means of second sensors 8, which may also again have an optical, acoustic, electrical and/or magnetic detection and transmit the detected signals to the evaluation unit. Downstream of the evaluation unit blower 8 is provided in the working segment 14, but before the output of the pitted fruits. The second blower 9 blow improperly pitted fruits into a sorting container 91.

### LIST OF REFERENCE NUMBERS

1 circulating receiving element track
10 first conveyor
11 first roller/wheel
12 second roller/wheel
13 receiving element
14 working segment
2 circulating plunger track
20 second conveyor
21 third roller/wheel
22 fourth roller/wheel
23 plunger holder
24 curved element
3 cups
31 passage opening
32 receptacle
33 vertical slot
34 groove
35 bead
36 sleeve
37 base opening
38 edge elevation
4 plungers
41 shaft
42 shaft tip
43 contact element
5 fruit delivery arrangement
6 first sensor
7 first blower
71 sorting container
8 second sensor
9 second blower
91 sorting container
F fruit

1. A machine for pitting fruit with a plurality of plungers (4) and a plurality of receiving elements (13) for the fruit (F) to be pitted, each receiving element (13) having a single fruit (F) receiving cup (3) with a passage opening (31) for the pit to be pushed out of the fruit (F), the receiving elements (13) guided on a circulating receiving element track (1) and the plungers (4) guided on a circulating plunger track (2) along a working segment (14) in parallel and in synchronism with one another along the working segment (14), wherein means for carrying out a reciprocating movement of the plunger (4) relative to the cups (3) are provided, and wherein upstream of the working segment (14) first sensors (6) are provided for detection of cups (3) double occupied with fruits.

2. The machine according to claim 1, wherein second sensors (8) are provided below the working segment (14) which detect the exit of the pit.

3. The machine according to claim 2, wherein as first or second sensors (6 or 8) an optical, acoustic, magnetic detector and/or detector using strain gauges are provided.

4. The machine according to claim 1, wherein below the passage opening (31) on the cup (3) an elastic sleeve (36) is provided through which the pit to be removed from the fruit by means of the plunger (4) can be pressed.

5. The machine according to claim 4, wherein marks, magnetizations or strain gauges are arranged on the elastic sleeve (36), with the aid of which a pit exit can be detected.

6. The machine according to claim 1, wherein downstream of the working segment (14) a checking device is arranged for sorting out defective pitted fruits prior to an output of the pitted fruits for further processing.

7. The machine according to claim 6, wherein the checking device is a second blower device (9) which ejects a defective pitted fruit detected by the second sensors (8) into a sorting container (91) arranged laterally to the transport direction on the receiving element track (1).

8. The machine according to claim 1, wherein a checking device is provided upstream of the working segment (14) and downstream of the first sensors (6) for sorting out fruits incorrectly supplied to the receiving elements (13).

9. The machine according to claim 8, wherein the checking device is a first blower device (7) which blows out a fruit or fruits, detected with the first sensors (6) to have been erroneously fed to a receiving element (13), into a sorting container (71) arranged on the receiving element track (1) and adjacent in a transport direction, before the pitting process begins.

10. The machine according to claim 1, wherein on the plunger track (2) a curved element (24) is provided and a plunger holder (23) is provided for each plunger (4), wherein the reciprocating movement of the plunger (4) slidably supported by the plunger holder (23) is controlled by the curved element (24).

11. The machine according to claim 10, wherein a sleeve is provided under each plunger holder (23), which sleeve sits on the fruit (F) during the reciprocating movement of the plunger (4) and after pitting holds back the fruit (F) in the cup (3).

12. A method for pitting fruits with a plurality of plungers (4) and a plurality of receiving elements (13) for the fruit (F) to be pitted, each receiving element (13) having a single fruit (F) receiving cup (3) with passage opening (31) for the pit to be pushed out of the fruit (F), the receiving elements (13) guided on a circulating receiving element track (1) and the plungers (4) guided on a circulating plunger track (2), guided parallel and synchronous to each other along a working segment (14), and carrying out a reciprocating movement of the plungers (4) relative to the cups (3) along the working segment (14), the method comprising measurement-technically monitoring each cup (3) upstream of the working segment (14) as to whether a single fruit (F) or several fruits are deposited, and discharging the fruits (F) of each cup (3) with several fruits.

13. The method according to claim 12, wherein after discharging the fruits (F) of a cup (3) with several fruits, this cup (3) is checked upstream of the working segment (14) as to whether the fruit discharge took place and in the event of a faulty discharge a second discharge is made by means of a blast of compressed air.

14. The method of claim 12, wherein the working segment (14) is monitored by measurement technology as to exit of a pit under the passage opening, wherein the fruits (F) of each cup (3), from which a pit exit was not detected, is discharged downstream of the working segment (14).

15. The method according to claim 14, wherein after discharging incorrectly pitted fruits the respective cup (3) is checked downstream of the working segment (14) as to whether the fruit discharge was successful and in the event of a faulty discharge, a second discharge is made by a blast of compressed air.
